(19) United States
(12) Patent Application Publication
(10) Pub. No.: US 2017/0148056 A1
(43) Pub. Date: May 25, 2017

(54) INFORMATION PROCESSING DEVICE, CONTROL METHOD, AND PROGRAM

(71) Applicant: SONY CORPORATION, TOKYO (JP)

(72) Inventors: SHINYA HATA, KANAGAWA (JP); NORIYUKI YAMAMOTO, KANAGAWA (JP); SEIICHI TAKAMURA, TOKYO (JP); MASASHI SEKINO, TOKYO (JP)

(21) Appl. No.: 15/323,510

(22) PCT Filed: May 1, 2015
(86) PCT No.: PCT/JP2015/063116

§ 371 Date: Jan. 3, 2017

(30) Foreign Application Priority Data
Jul. 24, 2014 (JP) 2014-151208

(51) Int. Cl. G06Q 30/02; G06F 17/30

(52) U.S. Cl. CPC G06Q 30/0255; G06F 17/30876; G06Q 30/0277

(57) ABSTRACT

[Object] To provide an information processing device, control method, and program that are capable of improving cost-effectiveness of advertisements by delivering the advertisements in accordance with stages in the process to occurrence of an event. [Solution] The information processing device includes: a content designation unit that designates content; an event designation unit that designates an event; a calculation unit that calculates a contribution ratio of the content designated by the content designation unit to occurrence of the event designated by the event designation unit, on the basis of a content viewing history of each of a plurality of users and an event occurrence history of each of the plurality of users; an association unit that associates each of a plurality of pieces of content with each of stages in a process to the event, on the basis of a contribution ratio of each piece of content to the occurrence of the event calculated by the calculation unit; and a delivery setting unit that configures a setting in a manner that advertisement information according to a stage is delivered to a piece of content associated with the stage.

### CROSS REFERENCE TO RELATED APPLICATIONS

This application is a U.S. National Phase of International Patent Application No. PCT/JP2015/063116 filed on May 1, 2015, which claims priority benefit of Japanese Patent Application No. JP 2014-151208 filed in the Japan Patent Office on Jul. 24, 2014. Each of the above-referenced applications is hereby incorporated herein by reference in its entirety.

### TECHNICAL FIELD

The present disclosure relates to information processing devices, control methods, and programs.

### BACKGROUND ART

In recent years, with development of information communication technologies, online purchase has been widely spread. For example, purchase ways in which content such as music, video, and the like managed by a server is purchased and the content is downloaded to a mobile terminal device via a network and played back, have been widespread. With regard to such technologies, for example, Patent Literature 1 discloses a system that recommends content matching user preference information and controls information amounts of the content to be recommended in accordance with a degree of the matching. The online purchase (so-called online shopping) is not limited to the purchase of music, video, and the like via downloading. The online purchase includes purchase of an item such as clothes, electrical appliances, or the like, and purchase of service such as hotel or flight reservation, for example.

As a model of a purchase process via the Internet, an AIDMA (attention, interest, desire, memory, and action) theory and an AISAS (attention, interest, search, action, share) theory are known.

In recent years, not only a last online advertisement clicked immediately before a conversion, but also another advertisement and a path of a user in online web pages are also considered as important. In general, the conversion is an end result acquired on commercial web sites. For example, the conversion is purchase of an item in the case of an online shopping site, and the conversion is member registration in the case of an information providing site or a community site. Attribution analysis is focused on as analysis that analyzes a web page viewing history to the conversion and examines a contribution ratio of each medium to the conversion.

As existing web advertisements, listing advertisements in a search result page of a searching engine or the like have been focused on. However, unfortunately the listing advertisement has a limited advertisement effect. Therefore, in recent years, display advertisements embedded and displayed as a part of a web page have been focused on again. In recent years, the display advertisements may be advertisements like a commercial message (CM) on a television (TV) in addition to a still image or the like, thanks to streaming delivery of an animation, video, or the like.

In addition, in recent years, the user tends to arrive at the conversion via various kinds of paths including simple click of an advertisement. For example, the user arrives at the conversion by being influenced by a display advertisement and conducting a search, or by clicking a display advertisement.

### CITATION LIST

### Patent Literature

Patent Literature 1: JP 2013-214340A

### DISCLOSURE OF INVENTION

### Technical Problem

Roles of advertisements are not limited to direct leading to a conversion. The roles of advertisements include various roles to making a user aware of an advertisement target, to making a user interested in the advertisement target, and the like. Therefore, it is necessary to present an appropriate advertisement to each user. However, according to the existing technologies, it has not been considered that what kind of advertisement should be posted on what kind of web page to obtain a higher effect, although effects of advertisement to a conversion have been analyzed.

In addition, if it is possible to determine which stage in a purchase process a user is in for each advertisement target, it is possible to present an appropriate advertisement to the user.

Accordingly, the present disclosure proposes an information processing device, control method, and program that are capable of optimizing advertisements by delivering the advertisements in accordance with stages in the process to occurrence of an event.

### Solution to Problem

According to the present disclosure, there is provided an information processing device including: a content designation unit that designates content; an event designation unit that designates an event; a calculation unit that calculates a contribution ratio of the content designated by the content designation unit to occurrence of the event designated by the event designation unit, on the basis of a content viewing history of each of a plurality of users and an event occurrence history of each of the plurality of users; an association unit that associates each of a plurality of pieces of content with each of stages in a process to the event, on the basis of a contribution ratio of each piece of content to the occurrence of the event calculated by the calculation unit; and a delivery setting unit that configures a setting in a manner that advertisement information according to a stage is delivered to a piece of content associated with the stage.

According to the present disclosure, there is provided a control method including: designating content; designating an event; calculating a contribution ratio of the designated content to occurrence of the designated event, on the basis of a content viewing history of each of a plurality of users and an event occurrence history of each of the plurality of users; associating each of a plurality of pieces of content with each of stages in a process to the event, on the basis of the calculated contribution ratio of each piece of content to the occurrence of the event; and configuring a setting in a manner that advertisement information according to a stage is delivered to a piece of content associated with the stage.

According to the present disclosure, there is provided a program for causing a computer to function as: a content designation unit that designates content; an event designation unit that designates an event; a calculation unit that calculates a contribution ratio of the content designated by the content designation unit to occurrence of the event designated by the event designation unit, on the basis of a content viewing history of each of a plurality of users and an event occurrence history of each of the plurality of users; an association unit that associates each of a plurality of pieces of content with each of stages in a process to the event, on the basis of a contribution ratio of each piece of content to the occurrence of the event calculated by the calculation unit; and a delivery setting unit that configures a setting in a manner that advertisement information according to a stage is delivered to a piece of content associated with the stage.

### Advantageous Effects of Invention

As described above, according to the present disclosure, it is possible to optimize advertisements by delivering the advertisements in accordance with stages in the process to occurrence of an event.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram illustrating an overview of an advertisement delivery system according to an embodiment of the present disclosure.

FIG. 2 is an explanatory diagram illustrating web advertisements according to a prior art.

FIG. 3 is an explanatory diagram illustrating delivery of web advertisements according to the embodiment of the present disclosure.

FIG. 4 is a block diagram illustrating an example of a configuration of a server according to the embodiment.

FIG. 5 is an explanatory diagram illustrating a user group example at the time of calculating CV contribution according to the embodiment.

FIG. 6 is a diagram illustrating a correlation between CV contribution of web pages (URLs) and a purchase process according to the embodiment.

FIG. 7 is a diagram illustrating an example of a UI for an advertisement delivery setting according to the embodiment.

FIG. 8 is a diagram illustrating an example of automatic optimization of an advertisement delivery setting according to the embodiment.

FIG. 9 is a diagram illustrating an example of advertisements having different creative to be delivered in accordance with stages in a purchase process according to the embodiment.

FIG. 10 is an explanatory diagram illustrating measurement of advertisement effect according to the embodiment.

FIG. 11 is a flowchart illustrating an operation process according to the embodiment.

FIG. 12 is an explanatory diagram illustrating a user group example at the time of calculating transition contribution according to the embodiment.

FIG. 13 is a diagram illustrating another example of a UI for an advertisement delivery setting according to the embodiment.

### MODE(S) FOR CARRYING OUT THE INVENTION

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

Note that the description is given in the following order.

1. Overview of advertisement delivery system according to embodiment of present disclosure
2. Configuration of server
3. Operation process

### 4. Modification

### 5. Conclusion

### 1. Overview of Advertisement Delivery System According to Embodiment of Present Disclosure

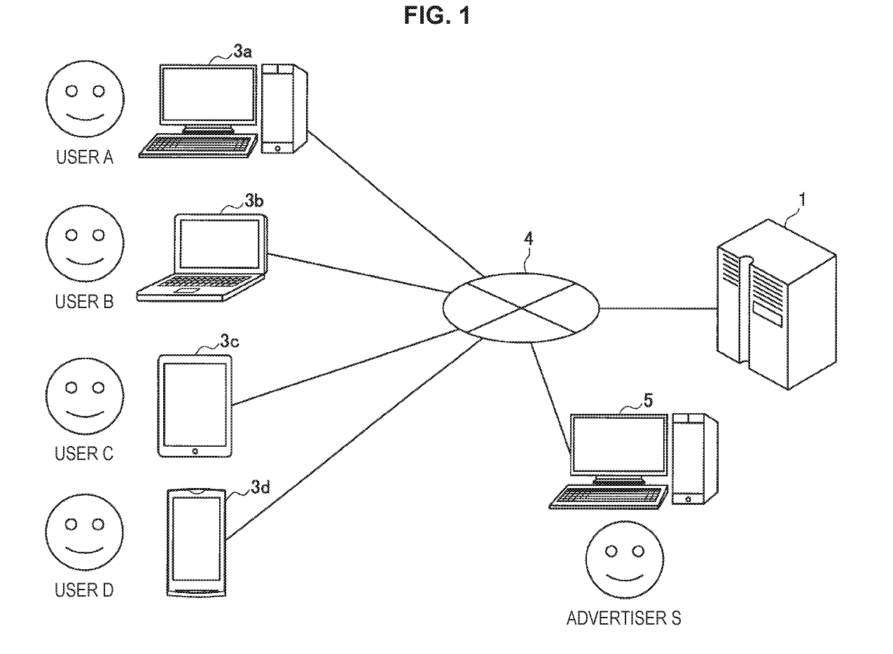

First, with reference to FIG. 1, an overview of an advertisement delivery system according to an embodiment of the present disclosure will be described. As illustrated in FIG. 1, the advertisement delivery system according to the embodiment includes information processing terminals 3 operated by users, a server 1 that calculates conversion (CV) contribution, and an information processing device 5 operated by an advertiser. The information processing terminals 3, the server 1, and the information processing device 5 are connected via a network 4.

As illustrated in FIG. 1, the information processing terminal 3 operated by a user may be an information processing terminal 3a implemented by a desktop personal computer (PC), an information processing terminal 3b implemented by a laptop PC, an information processing terminal 3c implemented by a tablet terminal, or an information processing terminal 3d implemented by a smartphone. Each of the users operates the information processing terminal 3 to view web pages on the network and to do shopping online.

The server 1 analyzes mass data including a generation history of conversions of target content (also referred to as advertisement product in this specification) with regard to each user and a web page viewing history of each user, and calculates conversion contribution (also referred to as CV contribution in this specification) with regard to a specific advertisement product in each web page. In addition, the server 1 defines which stage in a purchase process to a conversion of the specific advertisement product (in other words, process to event) each web page is in, in accordance with the calculated CV contribution.

The information processing device 5 operated by an advertiser S can configure settings of advertisement delivery according to a stage in the purchase process provided by the server 1.

### (Background)

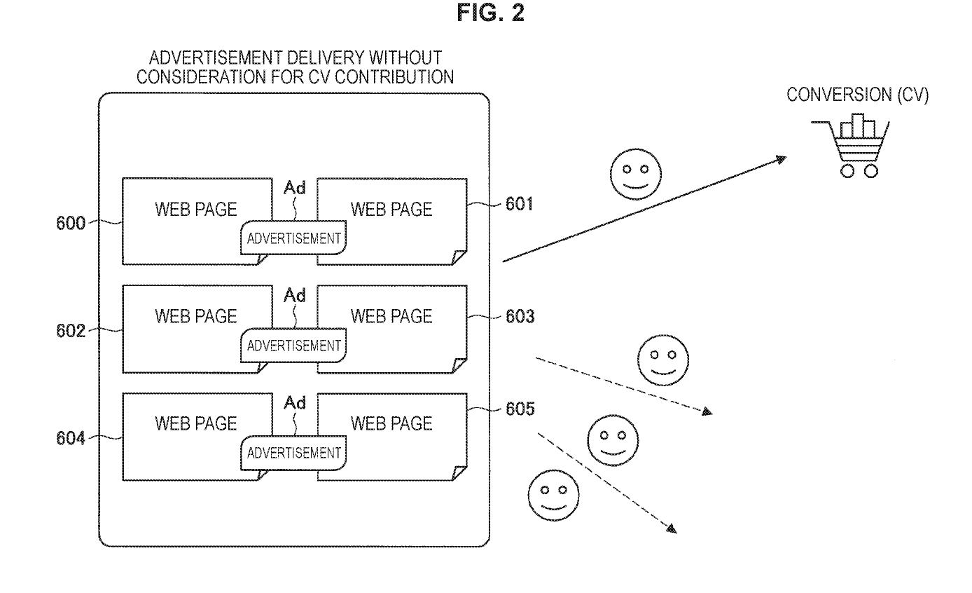

As illustrated in FIG. 2, according to web advertisements of a related art, advertisements are delivered without consideration for the CV contribution. Therefore, the same advertisement is placed in web pages 600 to 605. In other words, cost-effectiveness (conversion (CV) rate) of the web advertisement is low since the advertisement is not appropriate for each user.

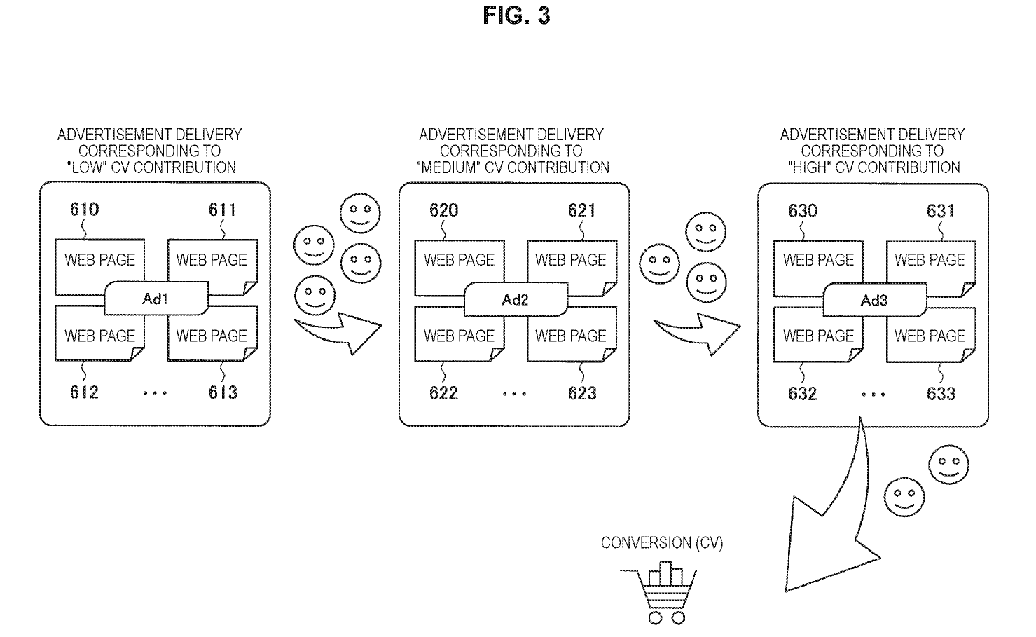

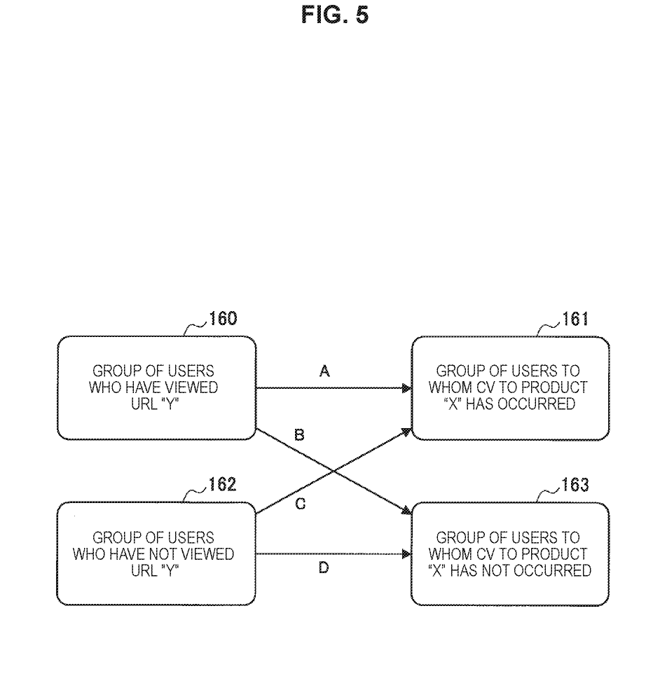

Therefore, according to the above described configuration, the embodiment quantifies contribution of the advertisement product to a conversion in each web page, and defines which stage in the purchase process each web page is in. Accordingly, it is possible to deliver an advertisement corresponding to a stage in the purchase process to a web page in the stage, and improve cost-effectiveness of the advertisement. Specifically, as illustrated in FIG. 3, an advertisement Ad1 corresponding to “low” CV contribution is delivered to web pages 610 to 613 having low CV contribution (for example, web page defined to be in “awareness stage” (to be described later with reference to FIG. 5) in purchase process). An advertisement Ad2 corresponding to “medium” CV contribution is delivered to web pages 620 to 623 having medium CV contribution (for example, web page defined to be in “interest stage” (to be described later with reference to FIG. 5) in purchase process). An advertisement Ad3 corresponding to “high” CV contribution is delivered to web pages 630 to 633 having high CV contribution (for example, web page defined to be in “comparative review stage” (to be described later with reference to FIG. 5) in purchase process). Such advertisements Ad1 to Ad3 have different creative according to the CV contribution, and have contents optimum for users at corresponding stages. Thereby, as a result, it is possible to increase the number of users who has arrived at the conversion (CV).

The quantification of contribution to a conversion is not limited to the web page. It is possible to quantify contribution of various kinds of content such as mass media, and other media, to a conversion, as long as a user who is performing operation is specified. By associating a conversion process with an advertisement of mass media or other media, it is possible to specify a conversion stage (purchase process) of a user and optimize an advertisement measure (contents, creative, media) in accordance with stages. The stage to be specified is not limited to the process to a conversion. The stage to be specified may be a process from calculation of contribution of content to occurrence of a certain specified event, to the event. In addition, the system according to the embodiment is not limited to the advertisement delivery. The embodiment can be applied to a system for proposing an application, social network service, or other service in accordance with which stage a user is in in a process to a certain event, with regard to every decision-making by the user when the certain event occurs.

The overview of the advertisement delivery system according to the embodiment of the present disclosure has been described. Next, a configuration of the server 1 in the advertisement delivery system according to the embodiment will be described.

### 2. Configuration of Server

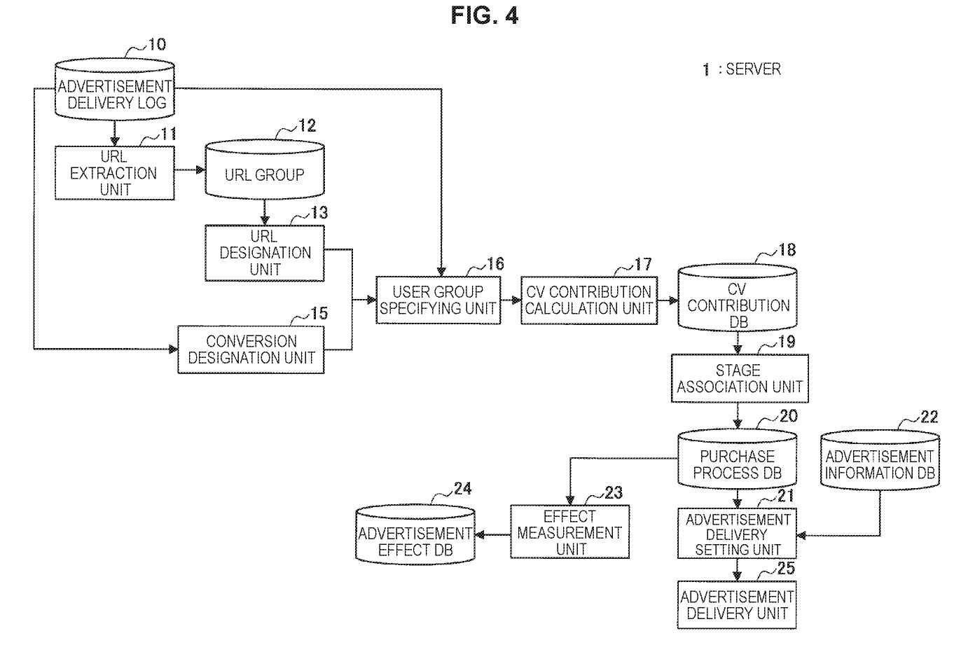

FIG. 4 is a block diagram illustrating an example of the configuration of the server 1 according to the embodiment. As illustrated in FIG. 4, the server 1 includes an advertisement delivery log 10, a Uniform Resource Locator (URL) extraction unit 11, a URL group 12, a URL designation unit 13, a conversion designation unit 15, a user group specifying unit 16, a CV contribution calculation unit 17, a CV contribution DB 18, a stage association unit 19, a purchase process DB 20, an advertisement delivery setting unit 21, an advertisement information DB 22, an effect measurement unit 23, an advertisement effect DB 24, and an advertisement delivery unit 25.

The advertisement delivery log 10 is a storage unit that stores information related to advertisement delivery such as what kind of advertisement has been delivered to (or placed in) which URL (in other words, web pace). The advertisement delivery log 10 also includes a URL viewing history and conversion information of each user. The conversion information is information of conversions of each user. The conversion information includes information of a last advertisement clicked immediately before the conversion, for example.

The URL extraction unit 11 extracts all URLs from the advertisement delivery log 10, and generates the URL group 12. The URL group 12 is a database that stores the URLs extracted by the URL extraction unit 11.

The URL designation unit 13 (content designation unit) designates a URL (example of content) of which CV contribution is calculated, from the URL group 12. The URL designation unit 13 outputs the designated URL to the user group specifying unit 16.

The conversion designation unit 15 (event designation unit) designates conversion information (example of event such as purchase of item via the Internet) used for the calculation of CV contribution in the advertisement delivery log 10, and outputs the conversion information to the user group specifying unit 16.

The user group specifying unit 16 specifies a user group used for calculating the CV contribution of the URL designated by the URL designation unit 13. Specifically, the user group specifying unit 16 specifies a first group including users who have viewed the URL designated by the URL designation unit 13, a second group including users to whom the conversion designated by the conversion designation unit 15 has occurred, a third group including users who have not viewed the URL designated by the URL designation unit 13, and a fourth group including users to whom the conversion designated by the conversion designation unit 15 has not occurred. The user group specifying unit 16 outputs the specified user groups to the CV contribution calculation unit 17. Viewing information of each user, information on a user who has arrived at the conversion, and the like are acquired from the advertisement delivery log 10.

The CV contribution calculation unit 17 calculates a contribution ratio (referred to as CV contribution in this specification) of the URL designated by the URL designation unit 13 to occurrence of a conversion designated by the conversion designation unit 15. More specifically, the number of users who belong to both the first group and the second group is indicated by A, and the number of users who belong to both the first group and the fourth group is indicated by B. In addition, the CV contribution calculation unit 17 defines that the number of users who belong to both the second group and the third group is indicated by C, and the number of users who belong to both the third group and the fourth group is indicated by D. Subsequently, the CV contribution calculation unit 17 calculates CV contribution by computation using (A/A+B) and (C/C+D).

FIG. 5 is an example of user groups when CV contribution of a URL “Y” to a product “X” is calculated. As illustrated in FIG. 5, the number of users who belong to both a first user group 160 including users who have viewed the URL “Y” and a second user group 161 including users to whom a conversion to the product “X” has occurred is indicated by A, and the number of users who belong to both the first user group 160 including users who have viewed the URL “Y” and a fourth user group 163 including users to whom a conversion to the product “X” has not occurred is indicated by B. In addition, the number of users who belong to both a third user group 162 including users who have not viewed the URL “Y” and the second user group 161 including users to whom a conversion to the product “X” has occurred is indicated by C, and the number of users who belong to both the third user group 162 including users who have not viewed the URL “Y” and the fourth user group 163 including users to whom a conversion to the product “X” has not occurred is indicated by D. In this case, CV contribution of the URL “Y” to the product “X” is calculated by using the following equation.

$$\begin{matrix}cvCtr ( X , Y ) = viewer CV rate - non \text{-} view CV rate \\ = \frac{A}{A + B} - \frac{C}{C + D}\end{matrix} \qquad [ Math . 1 ]$$

The CV contribution calculation unit 17 outputs the calculated CV contribution to the CV contribution DB 18.

The CV contribution DB 18 is a database that stores CV contribution of each URL calculated by the CV contribution calculation unit 17. The CV contribution unit 17 repeatedly calculates CV contribution for each URL designated by the URL designation unit 13. Therefore, CV contribution of a lot of URLs may be stored in the CV contribution DB 18.

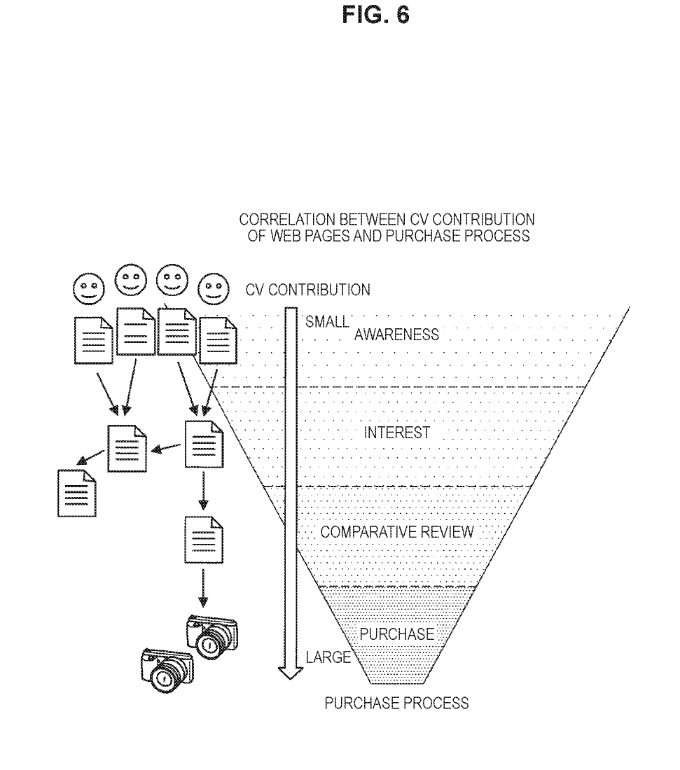

The stage association unit 19 associates (defines) URLs with respective stages in the process to a conversion, in accordance with CV contribution of the respective URLs stored in the CV contribution DB 18. Specifically, for example, as illustrated in FIG. 6, in the case where the conversion is purchase of an item, the purchase process that is a process to purchase is estimated to include stages of awareness, interest, comparative review, and purchase, for example. In this case, the stage association unit 19 associates (defines) each URL (in order words, web page) with each stage in the purchase process in accordance with CV contribution. For example, the stage association unit 19 may associate each URL with each stage, on the basis of a preset threshold of each stage. Subsequently, the stage association unit 19 outputs stages in the purchase process and URL association information to the purchase process DB 20.

The stages in the purchase process may be estimated in a user unit or in a user segment unit after recognizing preference of each user.

The purchase process DB 20 is a database that stores information on association between URLs and respective stages in the purchase process that are associated by the stage association unit 19.

The advertisement delivery setting unit 21 configures an advertisement delivery setting in accordance with the stages in the purchase process. More specifically, the advertisement delivery setting unit 21 configures a setting in a manner that an advertisement having different creative according to CV contribution is delivered to a URL associated with a predetermined stage in the purchase process. Thereby, an advertisement optimized in accordance with (CV contribution of) a stage associated with a URL is delivered to the URL. In other words, an optimum advertisement is shown in accordance with a current stage of a user (awareness stage, interest stage, or comparative review stage in purchase process). Therefore, cost-effectiveness of the advertisement can be improved, and as a result, it is possible to increase the number of users who has arrived at the conversion. Information on the advertisement to be delivered is acquired from the advertisement information DB 22.

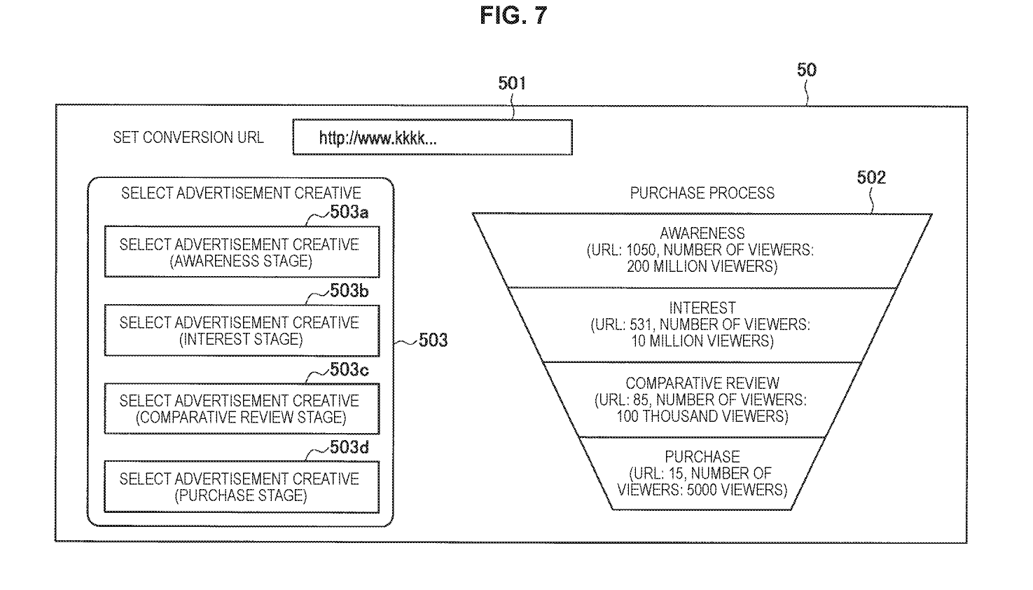

The advertisement delivery setting according to the stages in the purchase process may be configured in response to an operation instruction from the advertiser S after showing an user interface (UI) for configuring the advertisement delivery setting to the advertiser S, or may be automatically configured by the advertisement delivery setting unit 21. Next, the following description is given with reference to FIG. 7 to FIG. 9.

FIG. 7 is a diagram illustrating an example of the UI for the advertisement delivery setting according to the embodiment. A UI 50 in FIG. 7 is an image displayed on a display unit of the information processing device 5 operated by the advertiser S (or marketer). According to the embodiment, the advertisement delivery setting unit 21 in the server 1 also functions as a display control unit that transmits the UI 50 for advertisement delivery setting to the information processing device 5 and causes the display unit in the information processing device 5 to display the UI 50.

As illustrated in FIG. 7, the UI 50 includes a conversion setting box 501 by which a URL of a conversion is set, a selection screen 503 by which advertisement creative is selected in accordance with stages in the purchase process, and purchase process information 502 that indicates information on URLs associated with respective stages in the purchase process.

A URL to be set as a conversion is input to the conversion setting box 501. For example, a URL defined to be a conversion is input. The example of the URL includes URLs of a purchase completion screen, an inquiry completion screen, a brochure request screen, a registration completion screen, and the like, and URLs of an order screen, a home screen, a login screen, and the like.

As illustrated in FIG. 7, the purchase process information 502 indicates the estimated number of viewers and the number of URLs associated with respective stages in the purchase process (the number of URLs capable of advertisement delivery). The advertiser S decides which stage in the purchase process the advertisement is delivered to, by reference to the purchase process information 502.

The selection screen 503 is a screen through which advertisement creative corresponding to a stage is selected and advertisement delivery is ordered. The advertiser S selects at least any one of an advertisement creative selection button 503a corresponding to the awareness stage, an advertisement creative selection button 503b corresponding to the interest stage, an advertisement creative selection button 503c corresponding to the comparative review stage, and an advertisement creative selection button 503d corresponding to the purchase stage.

Subsequently, the information processing device 5 transmits an operation instruction based on the selection performed by the advertiser S to the server 1. According to the received operation instruction, the advertisement delivery setting unit 21 in the server 1 configures a setting in a manner that the advertisement creative corresponding to the selected stage is acquired (or automatically generated/edited) from the advertisement information DB 22 and delivered to a URL associated with the selected stage.

There has been described the case where the advertisement delivery setting unit 21 configures a setting in a manner that an advertisement corresponding to a stage is delivered in accordance with an operation instruction from the advertiser S. However, the setting of advertisement delivery according to the embodiment is not limited thereto. The advertisement delivery setting unit 21 may automatically control all the settings. Specifically, for example, the advertisement delivery setting unit 21 automatically optimizes delivery of advertisements by reference to metadata of the advertisements and information on a purchase process (for example, representative keyword extracted from URL of each stage).

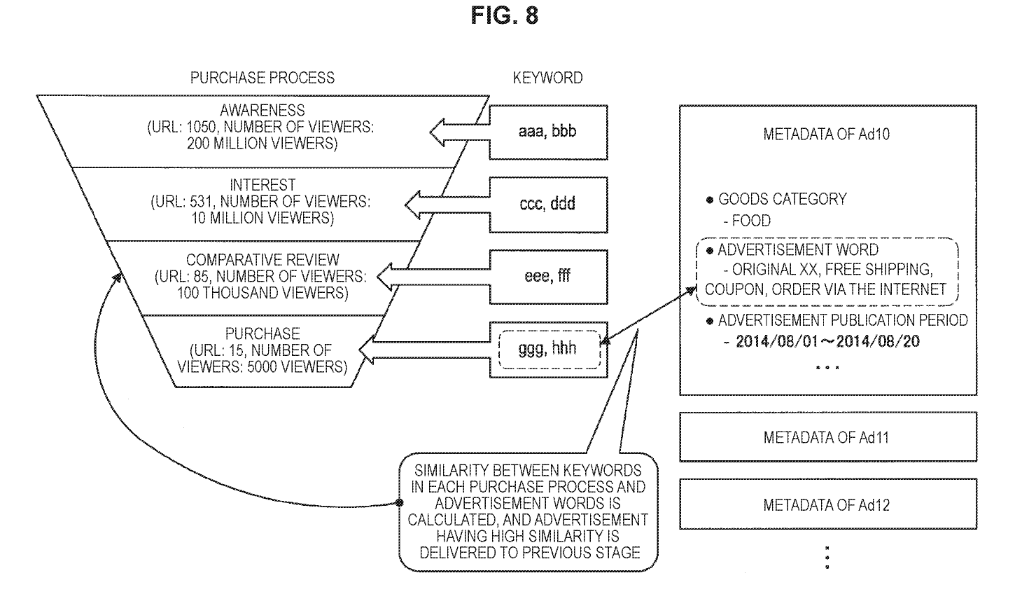

FIG. 8 is a diagram illustrating an example of automatic optimization of an advertisement delivery setting according to the embodiment. As illustrated in FIG. 8, the information on the purchase process includes extracted representative keywords (for example, frequently appearing keywords or words having high CV contribution) in addition to the number of URLs in which advertisement delivery is possible, and the estimated number of viewers. The advertisement delivery setting unit 21 calculates similarity between keywords in each purchase process and advertisement words included in metadata of an advertisement Ad10. The method for calculating the similarity is not specifically limited. A general algorithm for calculating similarity between words is used in the method for calculating the similarity.

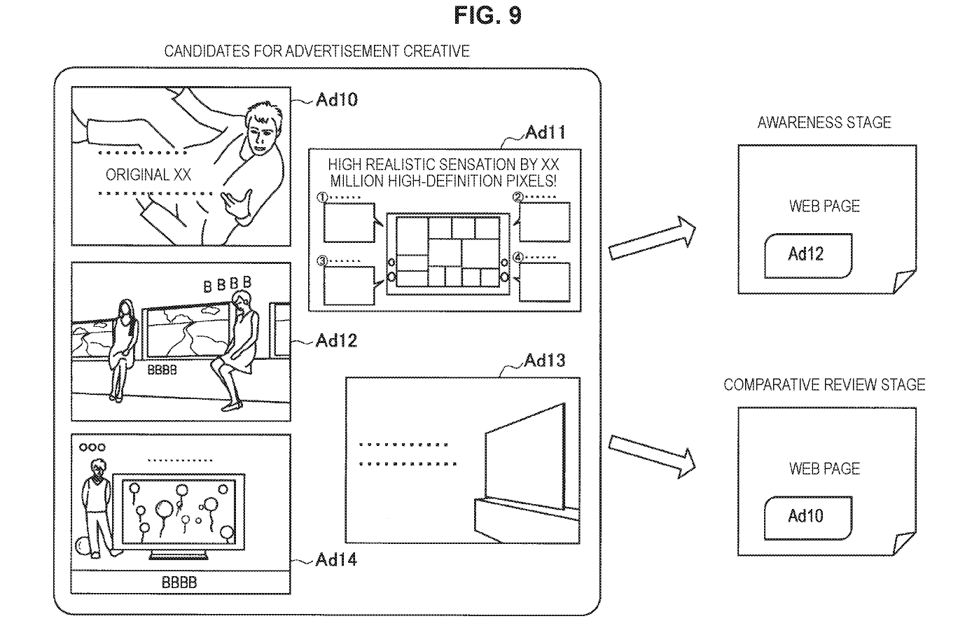

Subsequently, in the case where the advertisement words of the advertisement Ad10 has high similarity with a keyword in the purchase stage as illustrated in FIG. 8, the advertisement delivery setting unit 21 configures a setting in a manner that the advertisement Ad10 is delivered to the comparative review stage that is a stage previous to the purchase stage so as to shift a user to the purchase stage, and automatically optimizes the advertisement delivery. The advertisement delivery setting unit 21 performs similar optimization on advertisements Ad11, Ad12, . . . sequentially. The advertisements Ad10, Ad11, Ad12, . . . are advertisements for the same item, but generated in accordance with different advertisement measures (for example, change in advertisement creative). FIG. 9 is a diagram illustrating an example of advertisements having different creative (different advertisement measures) to be delivered in accordance with stages in a purchase process.

The advertisements Ad10 to Ad14 in FIG. 9 are each an advertisement for a liquid crystal display device (for example, large screen television), but each have a different words, sentence, design, person, and background. As described with reference to FIG. 8, for example, the advertisement delivery setting unit 21 refers to metadata of the advertisement Ad10, and delivers the advertisement Ad10 to a web page in the comparative review stage in the case where there is a keyword having high similarity with an advertisement word “original XX” is in the purchase stage. Such automatic optimization is sequentially performed on the other advertisement Ad11 to Ad14, and the advertisement Ad 12 is delivered to a web page in the awareness stage, for example.

The automatic optimization of advertisement delivery performed by the advertisement delivery setting unit 21 has been described. The above described advertisement delivery optimization based on similarity between words is just an example, and the embodiment is not limited thereto. For example, the advertisement delivery setting unit 21 may configure a setting in a manner that an advertisement having high advertising effect is delivered on the basis of advertising effect in each stage measured by the effect measurement unit 23 (to be described later).

The advertisement deliver unit 25 delivers a predetermined advertisement to a target URL in accordance with a setting configured by the advertisement delivery setting unit 21. A history of advertisements delivered by the advertisement delivery unit 25 is stored in the advertisement delivery log 10.

The advertisement information DB 22 is a database that stores information related to advertisements to be delivered. For example, the advertisement information DB 22 stores advertisement images (still image and moving image) to which metadata of advertisements are added. The metadata of advertisement includes an item category, advertisement words, and an advertisement publication period, and the like of an advertisement target (product).

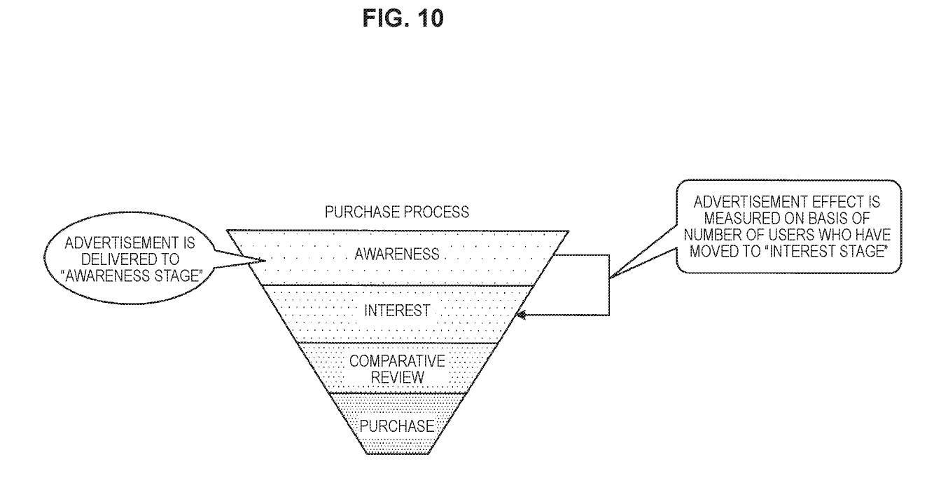

The effect measurement unit 23 measures advertisement effect of each advertisement in each stage. The advertisement effect is measured in accordance with a progress level of the purchase process, for example. Specifically, as illustrated in FIG. 10, in the case where an advertisement is delivered to a URL in the awareness stage in the purchase process for example, advertisement effect is measured on the basis of the number of users who have moved (shifted) to a URL in the interest stage. Alternatively, the effect measurement unit 23 can measure advertisement effects of the advertisements Ad10 and Ad11 delivered to the awareness stage by comparison measurement (which advertisement has higher effect) based on which advertisement has progressed the purchase process.

The advertisement effect DB 24 is a database that stores advertisement effect of each advertisement in each stage measured by the effect measurement unit 23.

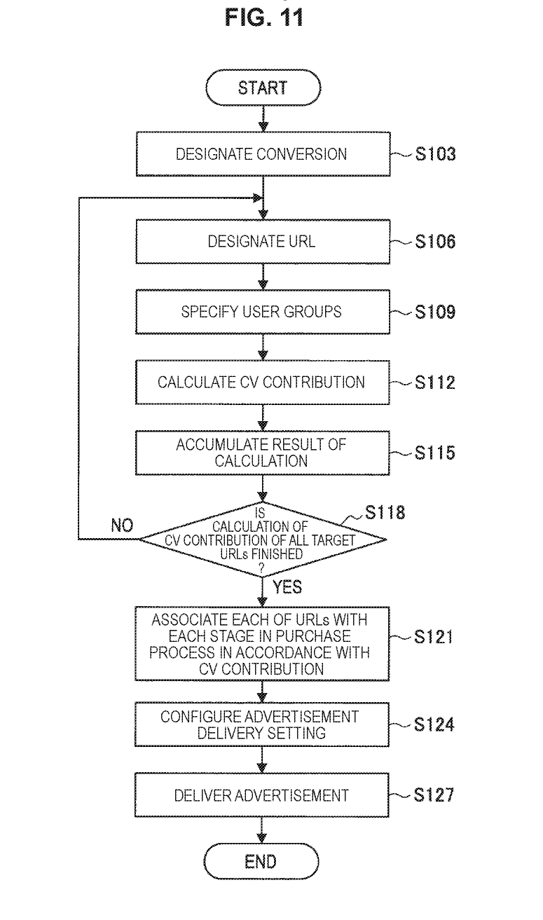

The detailed configuration of the server 1 according to the embodiment has been described. Next, with reference to FIG. 11, an operation process in the advertisement delivery system according to the embodiment will be described.

### 3. Operation Process

FIG. 11 is a flowchart illustrating an operation process in the advertisement delivery system according to the embodiment. As illustrated in FIG. 11, first, in Step S103, the conversion designation unit 15 in the server 1 designates a conversion (for example, purchase event of product X).

Next, in Step S106, the URL designation unit 13 designates one URL in the URL group 12 including URLs extracted from the advertisement delivery log 10.

Next, in Step S109, the user group specifying unit 16 specifies a first user group including users who have viewed the designated URL, a second user group including users to whom the designated conversion has occurred, a third user group including users who have not viewed the designated URL, and a fourth user group including users to whom the designated conversion has not occurred,

Next, in Step S112, the CV contribution calculation unit 17 calculates CV contribution of the designated URL to the product X by computation using the first to fourth user groups.

Next, in Step S115, the CV contribution DB 18 accumulates results of the calculation (CV contribution of URLs).

The processes in S106 to S115 are sequentially performed on all target URLs (S118).

Next, when the calculation of CV contribution of all the target URLs is finished (Yes in S118), the stage association unit 19 associates each of the URLs with each stage in the process to a conversion (purchase process) in accordance with the CV contribution of each of the URLs in Step S121.

Next, in Step S124, the advertisement delivery setting unit 21 configures an advertisement delivery setting in accordance with a predetermined stage, with respect to a URL associated with the predetermined stage. Specifically, the advertisement delivery setting unit 21 configures a setting in a manner that an advertisement corresponding to a stage indicated by an operation instruction from the advertiser S is delivered to a URL associated with the indicated stage. Alternatively, the advertisement delivery setting unit 21 configures a setting in a manner that advertisement delivery is automatically optimized and an advertisement corresponding to a stage determined to be a delivery target is delivered to a URL in the stage.

Subsequently, in Step S127, the advertisement delivery unit 25 delivers the advertisement in accordance with the setting configured by the advertisement delivery setting unit 21. On the other hand, the advertisement may be separately delivered by an advertisement server. In this case, the advertisement delivery setting unit 21 also functions as a transmission control unit that performs control in a manner that the set advertisement delivery information is transmitted to the advertisement server.

### 4. Modification

The details of the advertisement delivery system according to the embodiment have been described. In the above described embodiment, each URL is associated with each stage in the purchase process in accordance with the CV contribution of each URL. However, the present disclosure is not limited thereto. It may be possible that each URL is associated with each stage in the purchase process in view of transition contribution between two nodes (indicating URLs).

More specifically, the CV contribution calculation unit 17 according to a modification of the embodiment calculates contribution ratios of URLs to the designated conversion, and sequentially calculates transition contribution between the URLs. The transition contribution between URLs is calculated by computation using respective user groups specified by the user group specifying unit 16 according to the modification.

More specifically, as the user group used for calculating the transition contribution between two selected URLs, the user group specifying unit 16 specifies a first group including users who have viewed a first URL, a second group including users who have viewed a second URL, a third group including users who have not viewed the first URL, and a fourth group including users who have not viewed the second URL,

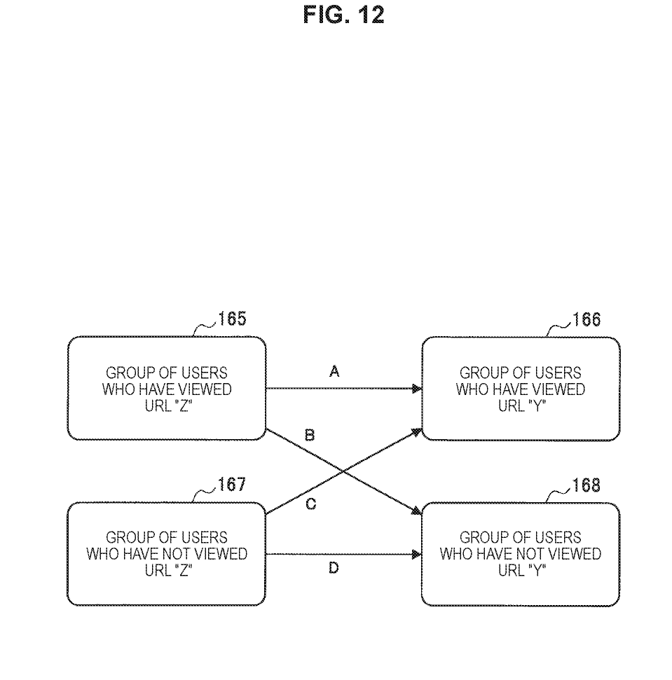

FIG. 12 illustrates an example of user groups when transmission contribution of a URL “Z” to a URL “Y” is calculated. As illustrated in FIG. 12, the number of users who belong to both a first user group 165 including users who have viewed the URL “Z” and a second user group 166 including users who have viewed the URL “Y” is indicated by A, and the number of users who belong to both the first user group 165 including users who have viewed the URL “Z” and a fourth user group 168 including users who have not viewed the URL “Y” is indicated by B. In addition, the number of users who belong to both the second user group 166 including users who have viewed the URL “Y” and a third user group 167 including users who have not viewed the URL “Z” is indicated by C, and the number of users who belong to both the third user group 167 including users who have not viewed the URL “Z” and the fourth user group 168 including users who have not viewed the URL “Y” is indicated by D. In this case, transmission contribution of the URL “Z” to the URL “Y” is calculated by using the following equation.

$$\begin{matrix}tsCtr ( Y , Z ) = Y viewing rate of Z viewers - \\ Y viewing rate of non Z viewers \\ = \frac{A}{A + B} - \frac{C}{C + D}\end{matrix} \qquad [ Math . 2 ]$$

Subsequently, on the basis of the above described calculation result of CV contribution and the transition contribution between URLs, the stage association unit 19 according to the modification can generate a conversion path of each URL linked to the designated conversion, cause a segment of the conversion path to correspond to a stage in the purchase process, and associate each URL with each stage.

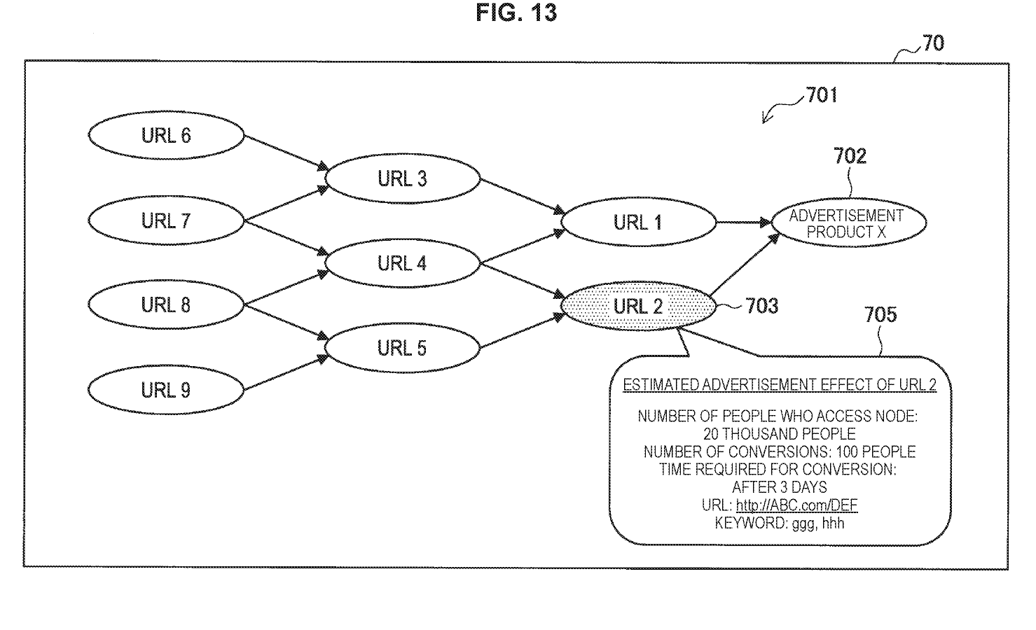

The generated conversion path may be used for the UI for advertisement delivery setting shown to the advertiser S. Next, the following description is given with reference to FIG. 13.

FIG. 13 is a diagram illustrating another example of the UI for advertisement delivery setting according to the embodiment. A UI 70 in FIG. 13 is an image displayed on a display unit of the information processing device 5 operated by the advertiser S (or marketer).

As illustrated in FIG. 13, the UI 70 includes a conversion path 701. The conversion path 701 includes a node 702 indicating the designated conversion (for example, purchase of product X) and nodes of respective URLs (first to ninth URLs) linked to the node 702. Specifically, the nodes of the first and second URLs having high CV contribution are linked to the designated conversion. Next, the nodes of the third, fourth, and fifth URLs having high transition contribution is linked to the first and second URL, and the nodes of the sixth to ninth URLs are linked to the third to fifth URLs. In this case, a segment including the first and second URLs is estimated to be in the “purchase stage”, a segment including the next third to fifth URLs are estimated to be in the “comparative review stage”, and a segment including the next sixth to ninth URLs are estimated to be in the “interest stage”.

When the advertiser S selects any of the nodes in the conversion path 701 as illustrated in FIG. 13, the UI 70 displays estimated advertisement effect display 705 of the selected node 703 (second URL, here). For example, the estimated advertisement effect display 705 includes the number of people who access the node (in other words, the number of viewers of URL), the number of conversions (in other words, the number of users who arrive at the conversion after viewing), time required for the conversion (in other words, required time from viewing to the conversion), a URL, keywords, and the like. Thereby, the advertiser S can check the estimated advertisement effect of the advertisement delivery target URL in advance.

Subsequently, the advertiser S selects a node (or segment) of the delivery target URL. The information processing device 5 transmits an operation instruction based on the selection performed by the advertiser S to the server 1. According to the received operation instruction, the advertisement delivery setting unit 21 in the server 1 configures a setting in a manner that the advertisement creative corresponding to a stage associated with the selected URL (or segment) is acquired from the advertisement information DB 22 and delivered to the selected URL (or URL included in segment).

### 5. Conclusion

As described above, the advertisement delivery system according to the embodiment of the present disclosure quantifies contribution of the advertisement product to a conversion in each web page, and defines which stage in the purchase process each web page is in. Thereby, it is possible to deliver an advertisement corresponding to a stage in the purchase process to a web page in the stage, optimize the advertisement, and improve cost-effectiveness of the advertisement.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, it is also possible to create a computer program for causing hardware such as a central processing unit (CPU), read only memory (ROM), random access memory (RAM), which are embedded in the server 1, to execute functions of the server 1. Moreover, it is possible to provide a computer-readable recording medium having the computer program stored therein.

Further, the effects described in this specification are merely illustrative or exemplified effects, and are not limitative. That is, with or in the place of the above effects, the technology according to the present disclosure may achieve other effects that are clear to those skilled in the art based on the description of this specification.

Additionally, the present technology may also be configured as below.

(1)

An information processing device including:

a content designation unit that designates content;

an event designation unit that designates an event;

a calculation unit that calculates a contribution ratio of the content designated by the content designation unit to occurrence of the event designated by the event designation unit, on the basis of a content viewing history of each of a plurality of users and an event occurrence history of each of the plurality of users;

an association unit that associates each of a plurality of pieces of content with each of stages in a process to the event, on the basis of a contribution ratio of each piece of content to the occurrence of the event calculated by the calculation unit; and

a delivery setting unit that configures a setting in a manner that advertisement information according to a stage is delivered to a piece of content associated with the stage.

(2)

The information processing device according to (1), further including

a display control unit that controls stage display in the process to the event,

wherein the delivery setting unit configures a setting in a manner that advertisement information according to a stage designated by a user via the stage display is delivered to each piece of content associated with the stage.

(3)

The information processing device according to (1) or (2), wherein

the delivery setting unit automatically configures a setting in a manner that advertisement information according to a corresponding stage is delivered to each piece of content associated with a stage in the process to the event.

(4)

The information processing device according to (3), wherein

the delivery setting unit configures a setting in a manner that advertisement information including an advertisement word similar to a keyword extracted from each piece of content associated with one stage in the process to the event is delivered to each piece of content associated with a stage previous to the one stage.

(5)

The information processing device according to any one of (1) to (4), wherein

the content is a web page.

(6)

The information processing device according to (5), wherein

the event is purchase of an item via the Internet.

(7)

The information processing device according to (6), wherein

the stages in the process to the event represent a purchase process, and

the purchase process includes stages of awareness, interest, comparative review, and purchase.

(8)

The information processing device according to any one of (1) to (7), further including

a group specifying unit that specifies a first group including users who have viewed the content designated by the content designation unit, a second group including users to whom the event designated by the event designation unit has occurred, a third group including users who have not viewed the content designated by the content designation unit, and a fourth group including users to whom the event designated by the event designation unit has not occurred,

wherein the calculation unit calculates the contribution ratio by computation using (A/A+B) and (C/C+D), where A represents the number of users who belong to both the first group and the second group, B represents the number of users who belong to both the first group and the fourth group, C represents the number of users who belong to both the second group and the third group, and D represents the number of users who belong to both the third group and the fourth group.

(9)

The information processing device according to any one of (1) to (8), wherein

the calculation unit calculates an event contribution ratio of each of a plurality of pieces of content to occurrence of a designated event, and a transition contribution ratio between pieces of content repeatedly selected among the plurality of pieces of content, on the basis of designation by the content designation unit and designation by the event designation unit, and

the association unit links content of the first group to the designated event in accordance with a level of the event contribution ratio, links content of the second group to the content of the first group in accordance with a level of the transition contribution ratio, subsequently repeats connection of content groups in accordance with a level of the transition contribution ratio, generates a path indicating a link between two or more pieces of content, and associates the content with stages in the process to the event.

(10)

The information processing device according to (9), further including

a display control unit that controls path display showing the link between the two or more pieces of content.

(11)

The information processing device according to (10), wherein

the delivery setting unit configures a setting in a manner that advertisement information according to a corresponding stage is delivered to a piece of content designated by a user via the path display.

(12)

A control method including:

designating content;

designating an event;

calculating a contribution ratio of the designated content to occurrence of the designated event, on the basis of a content viewing history of each of a plurality of users and an event occurrence history of each of the plurality of users;

associating each of a plurality of pieces of content with each of stages in a process to the event, on the basis of the calculated contribution ratio of each piece of content to the occurrence of the event; and

configuring a setting in a manner that advertisement information according to a stage is delivered to a piece of content associated with the stage.

(13)

A program for causing a computer to function as:

a content designation unit that designates content;

an event designation unit that designates an event;

a calculation unit that calculates a contribution ratio of the content designated by the content designation unit to occurrence of the event designated by the event designation unit, on the basis of a content viewing history of each of a plurality of users and an event occurrence history of each of the plurality of users;

an association unit that associates each of a plurality of pieces of content with each of stages in a process to the event, on the basis of a contribution ratio of each piece of content to the occurrence of the event calculated by the calculation unit; and

a delivery setting unit that configures a setting in a manner that advertisement information according to a stage is delivered to a piece of content associated with the stage.

### REFERENCE SIGNS LIST

1 server
10 advertisement delivery log
11 URL extraction unit
12 URL group
13 URL designation unit
15 conversion designation unit
16 user group specifying unit
17 CV contribution calculation unit
18 CV contribution DB
19 stage association unit
20 purchase process DB
21 advertisement delivery setting unit
22 advertisement information DB
23 effect measurement unit
24 advertisement effect DB
25 advertisement delivery unit
3, 3a to 3d information processing terminal
4 network
5 information processing device

1. An information processing device comprising:
a content designation unit that designates content;
an event designation unit that designates an event;
a calculation unit that calculates a contribution ratio of the content designated by the content designation unit to occurrence of the event designated by the event designation unit, on the basis of a content viewing history of each of a plurality of users and an event occurrence history of each of the plurality of users;
an association unit that associates each of a plurality of pieces of content with each of stages in a process to the event, on the basis of a contribution ratio of each piece of content to the occurrence of the event calculated by the calculation unit; and
a delivery setting unit that configures a setting in a manner that advertisement information according to a stage is delivered to a piece of content associated with the stage.

2. The information processing device according to claim 1, further comprising
a display control unit that controls stage display in the process to the event,
wherein the delivery setting unit configures a setting in a manner that advertisement information according to a stage designated by a user via the stage display is delivered to each piece of content associated with the stage.

3. The information processing device according to claim 1, wherein
the delivery setting unit automatically configures a setting in a manner that advertisement information according to a corresponding stage is delivered to each piece of content associated with a stage in the process to the event.

4. The information processing device according to claim 3, wherein
the delivery setting unit configures a setting in a manner that advertisement information including an advertisement word similar to a keyword extracted from each piece of content associated with one stage in the process to the event is delivered to each piece of content associated with a stage previous to the one stage.

5. The information processing device according to claim 1, wherein
the content is a web page.

6. The information processing device according to claim 5, wherein
the event is purchase of an item via the Internet.

7. The information processing device according to claim 6, wherein
the stages in the process to the event represent a purchase process, and
the purchase process includes stages of awareness, interest, comparative review, and purchase.

8. The information processing device according to claim 1, further comprising
a group specifying unit that specifies a first group including users who have viewed the content designated by the content designation unit, a second group including users to whom the event designated by the event designation unit has occurred, a third group including users who have not viewed the content designated by the content designation unit, and a fourth group including users to whom the event designated by the event designation unit has not occurred,
wherein the calculation unit calculates the contribution ratio by computation using (A/A+B) and (C/C+D), where A represents the number of users who belong to both the first group and the second group, B represents the number of users who belong to both the first group and the fourth group, C represents the number of users who belong to both the second group and the third group, and D represents the number of users who belong to both the third group and the fourth group.

9. The information processing device according to claim 1, wherein
the calculation unit calculates an event contribution ratio of each of a plurality of pieces of content to occurrence of a designated event, and a transition contribution ratio between pieces of content repeatedly selected among the plurality of pieces of content, on the basis of designation by the content designation unit and designation by the event designation unit, and
the association unit links content of the first group to the designated event in accordance with a level of the event contribution ratio, links content of the second group to the content of the first group in accordance with a level of the transition contribution ratio, subsequently repeats connection of content groups in accordance with a level of the transition contribution ratio, generates a path indicating a link between two or more pieces of content, and associates the content with stages in the process to the event.

10. The information processing device according to claim 9, further comprising
a display control unit that controls path display showing the link between the two or more pieces of content.

11. The information processing device according to claim 10, wherein
the delivery setting unit configures a setting in a manner that advertisement information according to a corresponding stage is delivered to a piece of content designated by a user via the path display.

12. A control method comprising:
designating content;
designating an event;
calculating a contribution ratio of the designated content to occurrence of the designated event, on the basis of a content viewing history of each of a plurality of users and an event occurrence history of each of the plurality of users;
associating each of a plurality of pieces of content with each of stages in a process to the event, on the basis of the calculated contribution ratio of each piece of content to the occurrence of the event; and
configuring a setting in a manner that advertisement information according to a stage is delivered to a piece of content associated with the stage.

13. A program for causing a computer to function as:
a content designation unit that designates content;
an event designation unit that designates an event;
a calculation unit that calculates a contribution ratio of the content designated by the content designation unit to occurrence of the event designated by the event designation unit, on the basis of a content viewing history of each of a plurality of users and an event occurrence history of each of the plurality of users;
an association unit that associates each of a plurality of pieces of content with each of stages in a process to the event, on the basis of a contribution ratio of each piece of content to the occurrence of the event calculated by the calculation unit; and
a delivery setting unit that configures a setting in a manner that advertisement information according to a stage is delivered to a piece of content associated with the stage.
